(19) United States
(12) Patent Application Publication
(10) Pub. No.: US 2009/0037170 A1
(43) Pub. Date: Feb. 5, 2009

(54) METHOD AND APPARATUS FOR VOICE COMMUNICATION USING ABBREVIATED TEXT MESSAGES

(76) Inventor: Willis Joe Williams, (US)

Correspondence Address: WILLIS JOE WILLIAMS, 3551 COUNTRY ROAD 100, CORINTH, MS, 38834, US

(21) Appl. No.: 11/831,009

(22) Filed: Jul. 31, 2007

(51) Int. Cl. G10L 15/00; G06F 17/28

(52) U.S. Cl. 704/235; 704/2; 704/E15.043

(57) ABSTRACT

The present invention relates generally to an apparatus and method for capturing and producing voice using abbreviated text messages, specifically, to translate voice into an abbreviated message text format for transmission in a communication system and to translate abbreviated message text received from a communication system to voice.

### FIELD OF THE INVENTION

The present invention relates generally to an apparatus and method for capturing and producing voice using abbreviated text messages, specifically, to translate voice into an abbreviated message text format for transmission in a communication system and to translate abbreviated message text received from a communication system to voice.

### BACKGROUND

Voice recognition is becoming increasingly robust in mobile devices to provide command and address lookup functions along with voice to text document generation. The system provides hands free capability such that a user can initiate voice communications by initiating a voice recognition application on the mobile device by a key operation, or by saying a voice command such as “dial”. Then the user provides an address identifier, such as “jim”, and the voice recognition system matches the identifier with an address list element and initiates a call to address “jim”. Further, the voice recognition system can initiate a direct call by converting numeric voice input into DTMF tones for dialing a number without the use of an address book. This system allows the user to connect a voice conversation while operating machinery, such as a car, with little or no distraction. In the case of text messaging, the user must enter text via the mobile device keyboard or other hand operations. This can distract the user from operating machinery, and cause safety issues. It is easily seen that a method for text messaging is needed that allows a user to transmit and receive messages in a hands free operation.

### BRIEF DESCRIPTION OF DRAWINGS

In order to provide a fuller understanding of this and other aspects of the present invention, one embodiment will be described, by way of example only, with reference to the accompanying drawings in which:

FIG. 1 is a schematic representation of a first embodiment of the system for transmission of a message text;

FIG. 2 is a schematic representation of a second embodiment of the system for receiving of a message text;

FIG. 3 is a schematic representation of a embodiment of the message slang text translator; and

FIG. 4 is a flow diagram of the process of translating text into message text slang.

### DETAILED DESCRIPTION OF PREFERRED EMBODIMENT

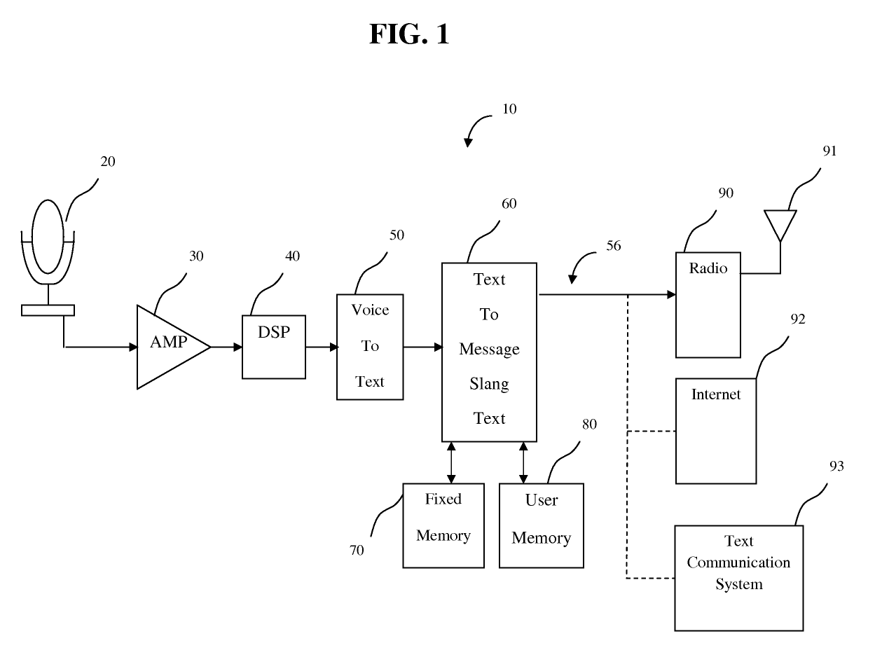

One embodiment of a mobile device 10 for converting analog voice to a set of message slang text strings shown in FIG. 1 comprises of a microphone 20 in combination with an amplifier 30 to capture and generate an analog voice signal for input to a digital signal processor 40 which converts the analog voice signal into a digital voice signal. The digital voice signal is then input into a voice to text translator 50 which translates the digital voice signal into a set of text strings. The set of text strings is then input into a text to message slang text translator 60, which in conjunction with a fixed memory 70 and a user memory 80 translates the set of text strings into a set of common message slang text strings and a set of user defined message slang text strings. The set of message slang text strings 56 is then sent over a plurality of transmitting systems such as a mobile device radio 90 with its communication antenna 91, an internet connection system 92, or other method of text communication system 93.

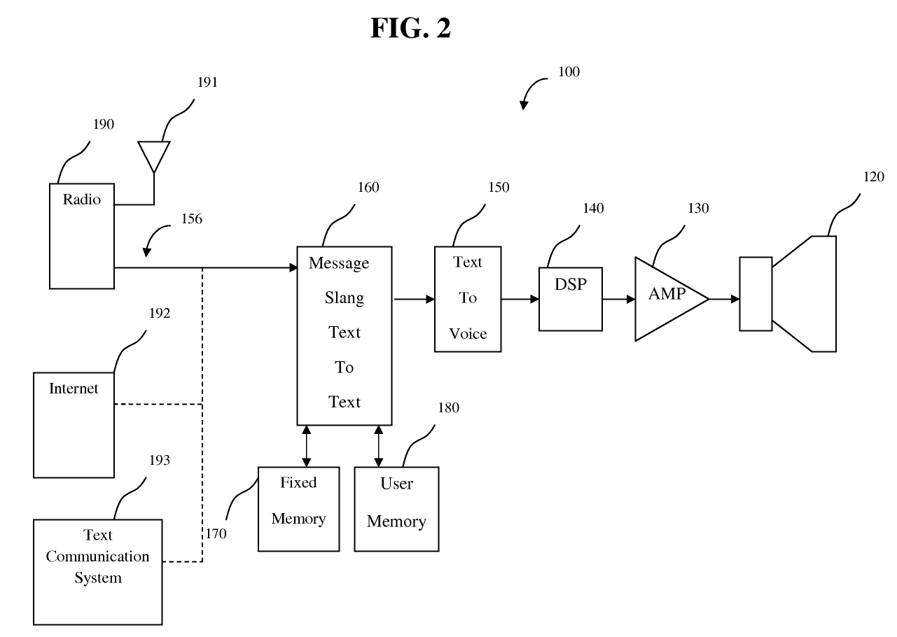

A further embodiment of a mobile device 100 for receiving message slang text strings and translating the message slang text string into analog voice shown in FIG. 2 comprises a plurality of receiving systems, such as a mobile device radio 190 with its communication antenna 191, an internet connection system 192, or other method of text communication system 193, for inputting a set of message slang text strings 156. The set of message slang text strings is then input into a message slang text to text translator 160 which in conjunction with fixed memory 170 and a user memory 180 translates the message slang text into a set of text strings. The set of text strings is then input into a text to voice translator 150, which converts the set of text strings into a digital voice signal. The digital voice signal is then translated from a digital signal into an analog signal by the digital signal processor 140, and the analog signal is then amplified by the audio amplifier 130 to drive the speaker 120 providing the voice message.

In the preferred embodiments of the invention a method for creation of message slang text in a text transmission system and for recovering message slang text in a text receiving system has been given. The message slang text is an abbreviation of regular text which allows for compression of the regular text and reduces the total length of characters used in the text transmission system. In systems today, text strings are converted to message slang text by the user. The preferred embodiment of the invention incorporates a message slang text to common text translator, which uses a fixed memory lookup that contains the commonly known common text with corresponding message slang text abbreviations, and also incorporates a user memory lookup which allows the individual users, group of users, or business and enterprise users to create and maintain a select set of plain text with corresponding message slang text abbreviations. This combination of common and user specified message slang text abbreviations provides a set of message slang text strings which is unique to a certain set of users or groups of users.

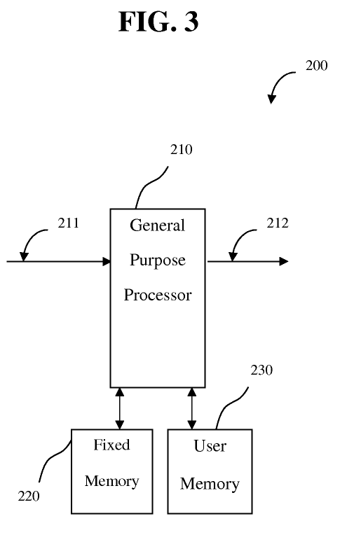

One embodiment of a message slang text translator is given in FIG. 3, where the message slang text translator 200 is the combination of a general purpose processor 210 with an input bus 211 and an output bus 212 and a set of memories 220 and 230. The general purpose processor users the first, or fixed, memory 220 to access a list of the common message slang text abbreviations. The general purpose processor also uses the second, or user, memory 230 to access a user defined set of message slang text abbreviations. In one mode of operation, the general purpose processor receives text strings on the input bus, and translates the text strings into message slang text to be output on the output bus. In another mode of operation, the general purpose processor receives message slang text on the input bus, and translates the message slang text into text strings to be output on the output bus. Thus the message slang text translator can convert message slang text to message text, or message text to message slang text.

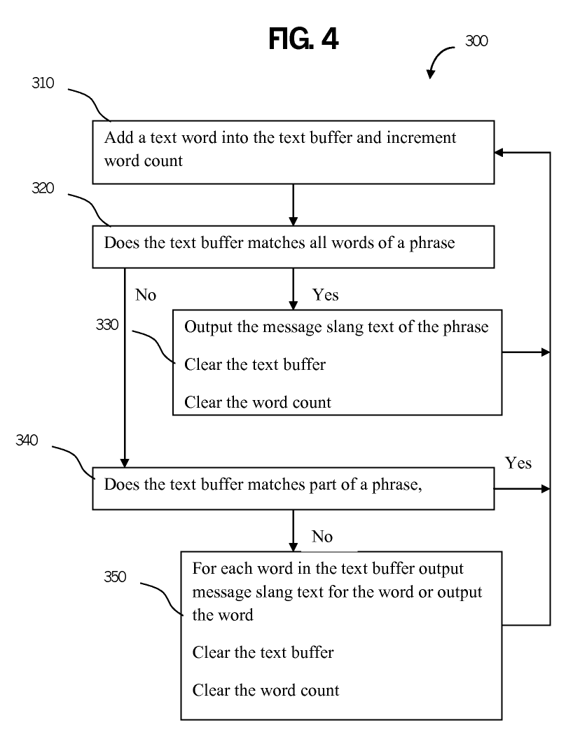

The operation of translating of message text into message slang text is shown in FIG. 4 by boxes representing typical instructions forming an application. The translation 300 starts with a message text that is input into a text buffer 310 and the word count is incremented. The word count keeps track of the number of words remaining in the text buffer. The text buffer is then checked for a complete match of a phrase 320. If a complete phrase is matched, then the message slang text for the phrase is output 330, and the text buffer and word count are cleared. The translation then continues at getting a message text into the text buffer 310. If the text buffer did not contain a complete match of a phrase, but did contain a partial match of the phrase 340, then the translation continues at getting a message text into the text buffer 310. And, if the text buffer does not match part of a phrase 350, then for each word in the text buffer, the message slang text for the word or the word itself is output. The text buffer and the word count are then cleared, and translation continues at getting a message text into the text buffer 310.

In summary there is described a message slang text system for obtaining audible voice and creating a text message composed of message text and message slang text where the text message is transmitted via a radio system, internet system, or message text system. The message slang text system also receives a text message from a radio system, internet system, or message text system which incorporates message text and message slang text and generates an audible voice message. The message slang text system thus provides a hands free operation for the creation a text message, and provides a hands free operation for receiving a text message.

The invention has been described by way of a preferred embodiment, and various modifications and improvements will occur to those persons skilled in the art. Therefore it should be understood that the preferred embodiment has been provided as an example and not as a limitation.

What is claimed is:

1. A communication system for receiving and transmitting voice constructed with abbreviated text messages comprising:
input voice capture means for collecting a first analog voice signal;
output voice generation means for outputting said second analog voice signal;
digital signal processing means for converting said first analog voice signal to a first digital voice signal and converting said second digital voice signal to a second analog voice signal;
voice processing means for converting said first digital voice signal to a first text string and for converting said second text string to a second digital voice signal;
abbreviated text translation means for converting said first text string to a first abbreviated text string and to convert a said second abbreviated text string to a second text string; and
a communication means for sending said first abbreviated text string and for receiving second abbreviated text string.

2. A communications system of claim 1 wherein the input voice capture means is comprised of a microphone and an amplifier.

3. A communications system of claim 1 wherein the output voice generation means is comprised of an amplifier and a speaker.

4. A communications system of claim 3 wherein the input voice capture means is comprised of a microphone and an amplifier.

5. A communication system for transmitting voice constructed with abbreviated text messages comprising;
input voice capture means for collecting a first analog voice signal;
digital signal processing means for converting said first analog voice signal to a first digital voice signal;
voice processing means for converting said first digital voice signal to a first text string;
abbreviated text translation means for converting said first text string to a first abbreviated text string; and
a communication means for transmitting said first abbreviated text string.

6. A communication system of claim 5 wherein the input voice capture means is comprised of a microphone and an amplifier.

7. A communication system for receiving voice constructed with abbreviated text messages comprising;
output voice generation means for outputting a first analog voice signal;
digital signal processing means for converting a first digital voice signal to said first analog voice signal;
voice processing means for converting a first text string to said first digital voice signal;
abbreviated text translation means for converting a first abbreviated text string to said first text string; and
a communication means for receiving said first abbreviated text string.

8. A communication system of claim 7 wherein the output voice generation means is comprised of an amplifier and a speaker.

9. An abbreviated text translation system comprising;
a text translator for translating abbreviated text strings into plain text strings.

10. An abbreviated text translation system of claim 9 wherein said text translator is a general purpose processor.

11. An abbreviated text translation system of claim 10 wherein said general purpose processor contains memory for storage of abbreviated text strings with their corresponding plain text strings.

12. An abbreviated text translation system of claim 11 wherein said memory comprises of general abbreviated text strings with their corresponding plain text strings, and user defined abbreviated text strings with their corresponding plain text strings.

13. An abbreviated text string translation system comprising;
a text translator for translating plain text strings into abbreviated text strings.

14. An abbreviated text translation system of claim 13 wherein said text translator is a general purpose processor.

15. An abbreviated text translation system of claim 14 wherein said general purpose processor contains memory for storage of plain text strings with their corresponding abbreviated text strings.

16. An abbreviated text translation system of claim 15 wherein said memory comprises of general plain text strings with their corresponding abbreviated text strings and user defined plain text strings with their corresponding abbreviated text strings.

17. An abbreviated text translation system comprising;
a text translator for translating plain text strings into abbreviated text strings and for translating abbreviated text strings into plain text strings.

18. An abbreviated text translation system of claim 17 wherein said text translator is a general purpose processor.

19. An abbreviated text translation system of claim 18 wherein said general purpose processor contains memory for storage of plain text strings with their corresponding abbreviated text strings.

20. An abbreviated text translation system of claim 19 wherein said memory comprises of general plain text strings with their corresponding abbreviated text strings and user defined plain text strings with their corresponding abbreviated text strings.
